(19) United States
(12) Patent Application Publication
(10) Pub. No.: US 2025/0367967 A1
(43) Pub. Date: Dec. 4, 2025

(54) WHEEL HUB BEARING UNIT WITH OPTIMIZED POSITIONING OF ROLLERS

(71) Applicant: AKTIEBOLAGET SKF, GOTEBORG (SE)

(72) Inventors: Lokesh NAGARAJAN, Northville, MI (US); Benjamin KORTY, Canton, MI (US); Fernando JUAREZ, Puebla (MX)

(21) Appl. No.: 18/732,837

(22) Filed: Jun. 4, 2024

(51) Int. Cl. B60B 27/00

(52) U.S. Cl. CPC B60B 27/001

(57) ABSTRACT

A wheel hub bearing unit includes a hub rotatable about an axis and having a flange connectable with a wheel, an outboard inner raceway and an inboard inner raceway. An outer ring is disposed about the hub, connectable with the vehicle and has an outboard outer raceway and an inboard inner raceway. Each outer raceway has a midpoint circle and a contact angle of each outer raceway is defined by a separate line perpendicular to the raceway through the midpoint circle, the two lines intersecting at a vertex point. A midpoint spacing line extends axially between the raceway midpoint circles and the vertex point is spaced axially from a center of the spacing line by no greater than five millimeters. Each contact angle is between ten and twenty-five degrees and the difference between the radii of the two midpoint circles is between three and ten millimeters.

### BACKGROUND OF THE INVENTION

The present invention relates to bearings, and more particularly to wheel hub bearing units.

Wheel hub bearing units are generally known in the bearing and automotive industries and are used to rotatably couple wheels to vehicles such as automobiles and trucks. A wheel hub bearing unit typically includes a cylindrical hub connectable with an axle, an outer ring disposed about the hub, and one or more rows or sets of rolling elements disposed between the hub and the outer ring. In certain constructions, the hub is rotatable about a central axis and includes a radial flange adapted to receive a wheel and the outer ring is fixedly connected with the vehicle, either to a steering knuckle or suspension component. In other configurations, the hub is mounted to a fixed shaft and the outer ring rotates about a central axis through the shaft and has a flange adapted to receive a wheel.

With either basic structure, the wheel hub bearing unit ordinarily includes two sets or rows of rolling elements, which may be rollers, cylindrical rollers, tapered rollers, or any other appropriate type of rolling elements and/or a combination thereof. When designing a wheel hub bearing unit for a specific application, consideration must be given to minimizing friction, providing sufficient structural rigidity to reliably support all anticipated loading, and reducing mass and space requirements for assembly into a vehicle.

### SUMMARY OF THE INVENTION

In one aspect, the present invention is a wheel hub bearing unit for rotatably coupling a wheel with a vehicle, the wheel being rotatable about a central axis, comprising a hub rotatable about the central axis and having an outboard axial end, an inboard axial end, an annular flange extending radially outwardly from the outboard end and configured to connect with the wheel, a first frustoconical outer circumferential surface providing an outboard inner raceway and a second frustoconical outer circumferential surface spaced axially from the first frustoconical outer circumferential surface and providing an inboard inner raceway. An outer ring is disposed about the hub and is configured to connect with the vehicle, the outer ring having a first frustoconical inner circumferential surface providing an outboard outer raceway, the outboard outer raceway being disposed about the outboard inner raceway, and a second frustoconical inner circumferential surface spaced axially from the first frustoconical inner circumferential surface and providing an inboard outer raceway, the inboard outer raceway being disposed about the inboard inner raceway. A plurality of outboard tapered rollers is disposed between the hub and the outer ring, spaced circumferentially about the central axis and rollable upon the outboard inner raceway and the outboard outer raceway and a plurality of inboard tapered rollers is disposed between the hub and the outer ring, spaced circumferentially about the central axis and rollable upon the inboard inner raceway and the inboard outer raceway.

Further, each one of the outboard outer raceway and the inboard outer raceway has first and second axial ends and a midpoint circle centered between the first and second axial ends. An outboard contact angle is defined by a line perpendicular to the outboard outer raceway extending through the midpoint circle of the outboard outer raceway and a line perpendicular to the central axis and an inboard contact angle is defined by a line perpendicular to the inboard outer raceway extending through the midpoint circle of the inboard outer raceway and a line perpendicular to the central axis. The line perpendicular to the outboard outer raceway and the line perpendicular to the inboard outer raceway intersect at a vertex point. Further, a midpoint spacing line extends axially between the midpoint circle of the outboard outer raceway and the midpoint circle of the inboard outer raceway.

Preferably, the vertex point is spaced axially from a center of the midpoint spacing line by a distance of no greater than five millimeters (5 mm) and each one of the outboard contact angle and the inboard contact angle has a value between ten degrees) (10° and twenty-five degrees) (25°. Also preferably, the midpoint circle of the outboard outer raceway has a radius about the central axis and the midpoint circle of the inboard outer raceway has a radius about the central axis, a difference between the radius of the outboard midpoint circle and the radius of the inboard midpoint circle being within a range of three millimeters (3 mm) and ten millimeters (10 mm). Further, each roller of the outboard row of tapered rollers has a first axial length and each roller of the inboard row of tapered rollers has a second axial length, a ratio of the second axial length to the first axial length is preferably between 1.0 and 2.0.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a wheel hub bearing unit in accordance with the present invention, shown with broken-away, more diagrammatically depicted portions of a wheel and a vehicle;

FIG. 2 is an axial cross-sectional view of an inner hub of the wheel hub bearing unit;

FIG. 3 is an axial cross-sectional view of an outer ring of the wheel hub bearing unit;

FIG. 4 is a more enlarged, broken-away axial cross-sectional view of an outboard roller and portions of outboard raceways of the wheel hub bearing unit;

FIG. 5 is a more enlarged, broken-away axial cross-sectional view of an inboard roller and portions of inboard raceways of the wheel hub bearing unit;

FIG. 6 is a broken-away, enlarged, axial cross-sectional view of an upper portion of the wheel hub bearing unit, including indications of a vertex defined by a line through a roller contact midpoint circle of an outboard outer raceway and a line through a roller contact midpoint circle of an inboard outer raceway, and a spacing line segment between outboard midpoint circle and the inboard midpoint circle; and

FIG. 7 is another broken-away, enlarged, axial cross-sectional view of an upper portion of the wheel hub bearing unit, including indications of a radius of the outboard midpoint circle and a radius of the inboard midpoint circle.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. The terms “outboard” and “inboard” refer to directions more distal from and more proximal to, respectively, a geometric center of a vehicle. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

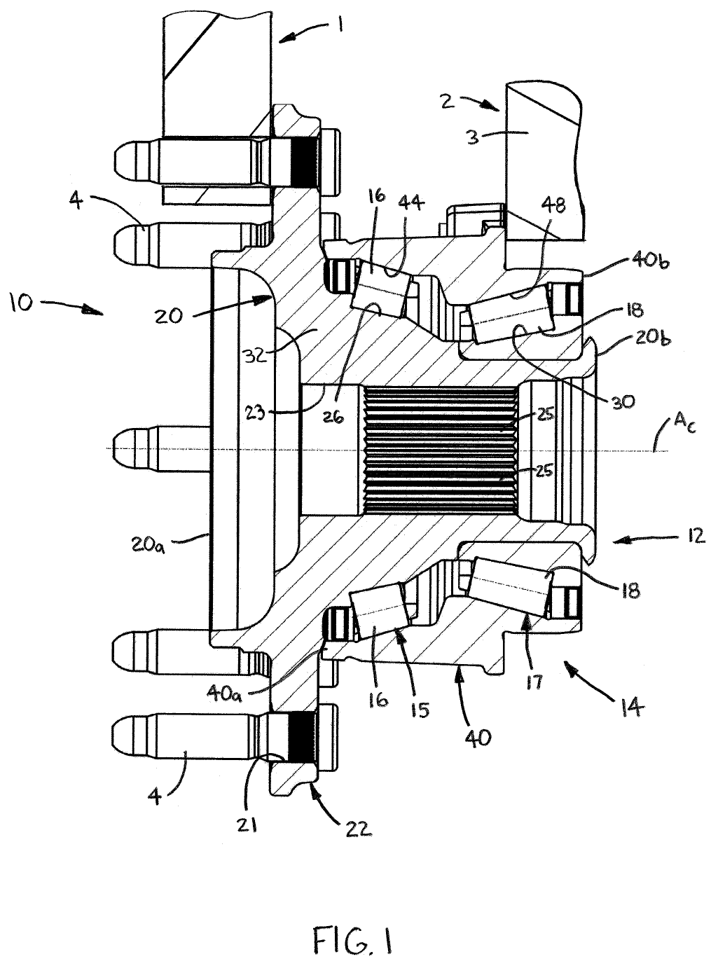

Referring now to the drawings in detail, wherein like numbers are used to indicate like elements throughout, there is shown in FIGS. 1-7 a wheel hub bearing unit 10 for rotatably coupling a wheel 1 with a vehicle 2, particularly a steering knuckle or a suspension component (either being indicated by the same reference element 3), the wheel 1 being rotatable about a central axis A_{C}. The wheel hub bearing unit 10 basically comprises a hub 12 rotatable about the central axis A_{C}, an outer ring 14 disposed about the hub 12, an outboard row 15 of a plurality of tapered rollers 16 disposed between the hub 12 and the outer ring 14 and an inboard row 17 of a plurality of tapered rollers 18 disposed between the hub 12 and the ring 14 and spaced axially from the plurality of rollers 16, the two sets of rollers 16, 18 rotatably coupling the hub 12 with the outer ring 14. The hub 12 and the outer ring 14 are configured, i.e., constructed, assembled, etc., so as to position the rollers 16, 18 in locations which optimize the performance of the wheel hub bearing unit 10, as discussed in detail below.

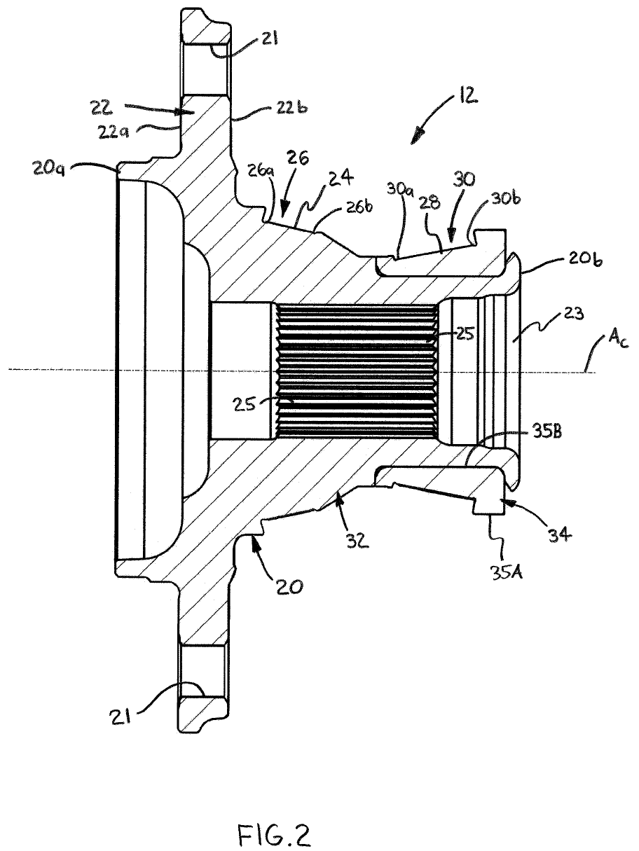

Referring to FIGS. 1 and 2, the hub 12 includes a generally cylindrical body 20 having an outboard axial end 20a, an opposing inboard axial end 20b and an annular flange 22 extending radially outwardly from the outboard end 20a and having opposing radial surfaces 22a, 22b. The hub flange 22 is configured to connect with the wheel 1, preferably by means of a plurality of fasteners 4 extending through holes 21 in the flange 22. The body 20 has a first outer circumferential surface 24 providing an outboard inner raceway 26 and a second frustoconical outer circumferential surface 28 spaced axially from the first frustoconical outer circumferential surface 24 and providing an inboard inner raceway 30. Preferably, the first frustoconical outer circumferential surface 24 faces generally toward the inboard axial end 20b of the hub 12 and the second frustoconical outer circumferential surface 28 faces generally toward the outboard axial end 20a of the hub 12.

Further, the hub cylindrical body 20 also preferably includes a main body portion 32 and an annular ring 34 disposed about the main body portion 32 adjacent to the inboard axial end 20b. The annular ring 34 has an outer circumferential surface 35A including the frustoconical outer surface 28 providing the inboard inner raceway 30 and an inner circumferential surface 35B providing a bore for receiving a section of the main body portion 32. However, the cylindrical body 20 may alternatively be formed as an integral body including the frustoconical surface 28 formed directly on the body 20. Furthermore, the hub body 20 preferably also has an inner circumferential surface 23 defining a bore for receiving an axle (not shown) and a plurality of axial splines 25 formed in the inner surface 23 for engaging with mating splines of the axle.

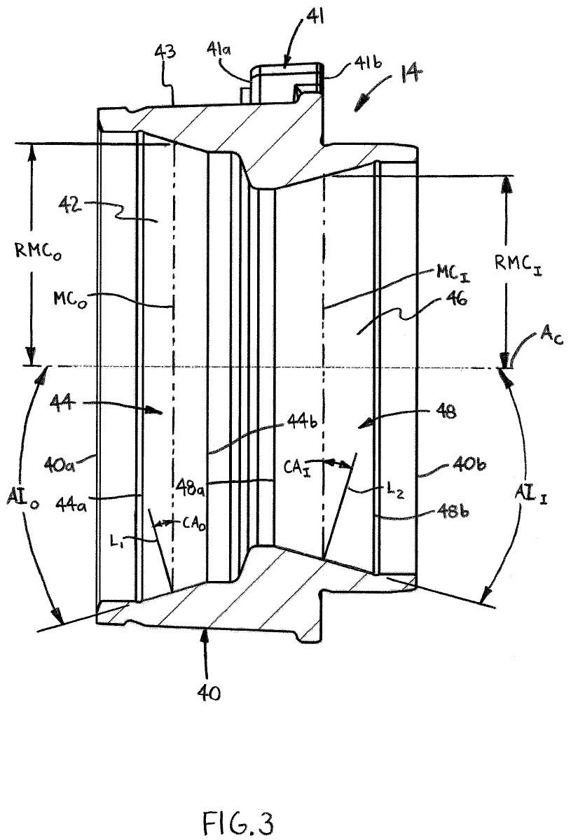

Referring now to FIGS. 1 and 3, the outer ring 14 is configured to connect with the vehicle 2, preferably with a steering knuckle or suspension component 3, and includes a generally circular cylindrical body 40 with an outboard axial end 40a and an opposing inboard axial end 40b. The outer ring body 40 preferably has at least one flange 41 extending radially outwardly from the outer circumferential surface 43, the outer ring flange(s) 41 each having outer and inner axial ends 41a, 41b and being configured to connect with a steering knuckle/suspension component 3 by means of threaded fasteners (none shown).

The outer ring cylindrical body 40 further has a first frustoconical inner circumferential surface 42 providing an outboard outer raceway 44 and a second frustoconical inner circumferential surface 46 spaced axially from the first frustoconical inner circumferential surface 42 and providing an inboard outer raceway 48. When the outer ring 14 is disposed about the hub 12, the outboard end 40a of the ring 14 is disposed adjacent to the hub flange 22, the ring inboard end 40b is disposed adjacent to the hub inboard end 20b, the outboard outer raceway 44 is disposed about the outboard inner raceway 26 and the inboard outer raceway 48 is disposed about the inboard inner raceway 30.

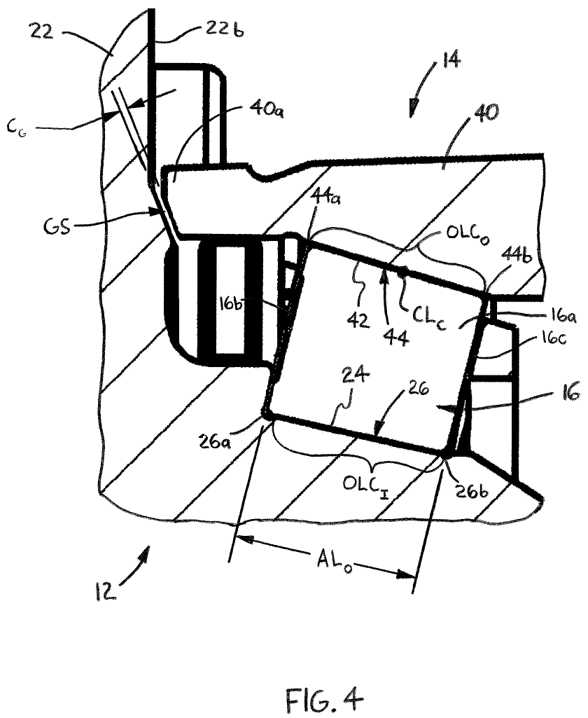

Preferably, each one of the hub body 20 and the ring cylindrical body 40 is sized and formed such that a spacing gap GS (FIG. 4) is defined between the hub flange 22 and the outboard end 40a of the ring 14, the gap GS having a clearance CG between the inner radial surface 23B of the flange 22 and a radial surface (not indicated) on the outboard end 40a with a value of no greater than three hundred thousandths of a millimeter (0.300 mm) and at least forty thousandths of a millimeter (0.040 mm). As such, impact loads exerted on the hub bearing unit (10) (e.g., by a wheel hitting a curb, etc.) will be primarily transferred from the hub 12 to the outer ring 14 by means of contact between the flange 22 and the outboard end 40a, rather than through the rollers 16, 18, which substantially reduces the likelihood of brinelling of the raceways 26/44 and 30/48. Although the gap GS is shown angled in FIG. 4, such that the clearance CG extends both axially and radially, the gap GS may formed between entirely vertical radial surfaces such that the clearance CG is entirely axial.

Further, the frustoconical inner surface 42 is spaced axially from and preferably faces generally toward the ring outboard axial end 40a and the frustoconical inner surface 46 is spaced axially from faces generally toward the ring inboard axial end 40b. As such, the outboard rollers 16 and the inboard rollers 18 are generally arranged in an O-type configuration when disposed on the raceway pairs 26/44 and 30/48, as is generally well known in the field of bearings. Further, as indicated in FIG. 3, each frustoconical inner surface 42, 46 has an angle of inclination AI_{O}, AI_{I}, respectively, with respect to the central axis A_{C} that establishes a contact angle CA_{O}, CA_{I} of each roller 16, 18, respectively, as described below; specifically, each contact angle CA_{O}, CA_{I} is perpendicular to each respective angle of inclination AI_{O}, AI_{I}.

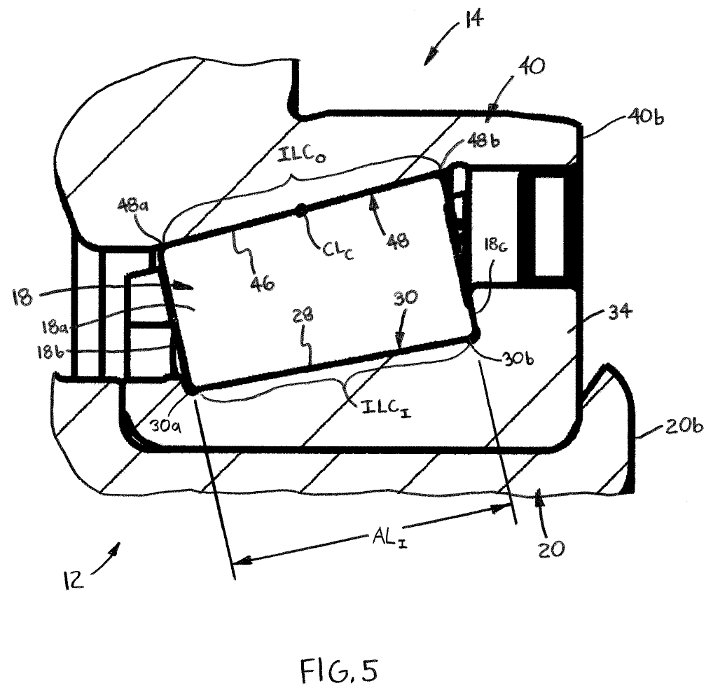

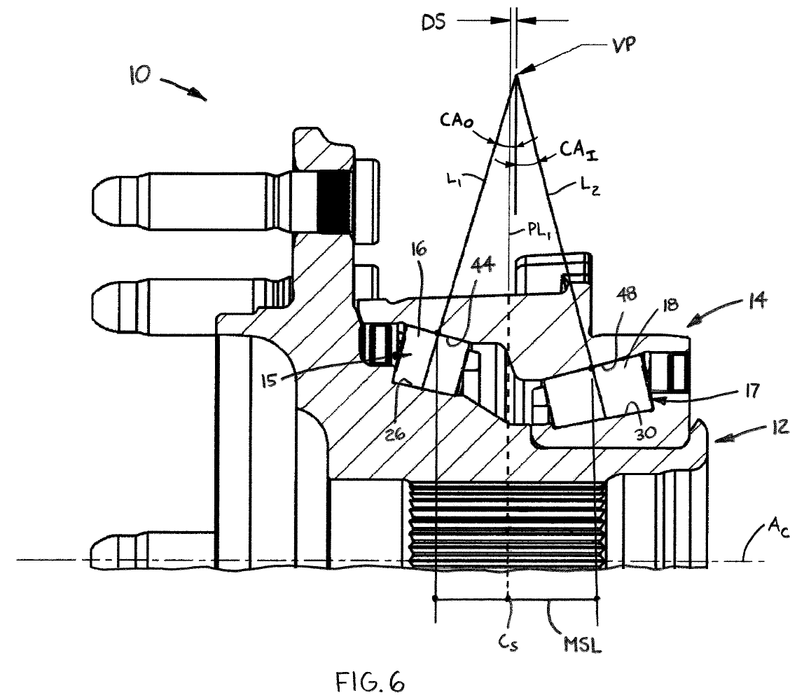

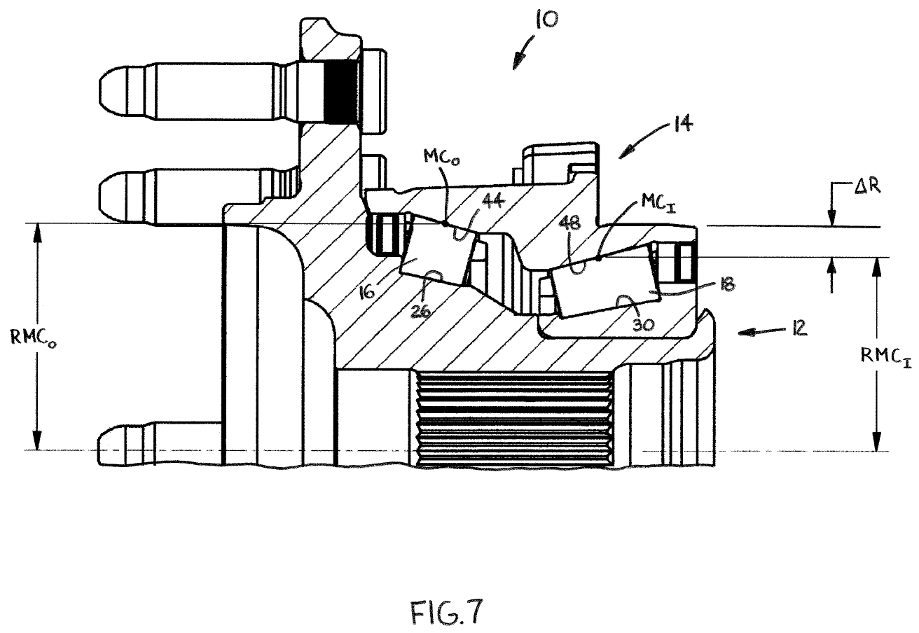

Referring to FIGS. 3-7, the outboard outer raceway 44 has first and second axial ends 44a, 44b and a midpoint circle MC_{O} centered between the first and second axial ends 44a, 44b and similarly, the inboard outer raceway 48 has first and second axial ends 48a, 48b and a midpoint circle MC_{I} centered between the first and second axial ends 48a, 48b. Each midpoint circle MC_{O}, MC_{I} is a theoretical construct which indicates the path traversed by the center CL_{C} of the line of contact OLC_{O} (FIG. 4), ILC_{O} (FIG. 5) of each roller 16, 18, respectively, on the outboard outer raceway 44 and on the inboard outer raceway 48 as the rollers 16, 18 circulate about the central axis A_{C}, as discussed in further detail below. Also, each midpoint circle MC_{O}, MC_{I} extends circumferentially around the central axis A_{C} and is spaced therefrom by a midpoint circle radius RMC_{O}, RMC_{I}, respectively, as indicated in FIG. 7. Furthermore, a midpoint spacing line MSL extends axially between the midpoint circle MC_{O} of the outboard outer raceway 44 and the midpoint circle MC_{I} of the inboard outer raceway 48, as shown in FIG. 6 and discussed in further detail below.

As shown in FIGS. 1 and 4-7, the outboard row 15 of tapered rollers 16 and the inboard row 17 of tapered rollers 18 are each disposed between the hub 12 and the outer ring 14 and are spaced circumferentially about the central axis A_{C}. The “outboard” rollers 16 are rollable simultaneously upon the outboard inner raceway 26 and the outboard outer raceway 44 and the “inboard” rollers 18 are rollable simultaneously upon the inboard inner raceway 30 and the inboard outer raceway 48, such that the two rows 15, 17 rotatably couple the hub 12 and the outer ring 14.

Referring particularly to FIG. 4, As mentioned above, each roller 16 of the outboard row 15 simultaneously contacts the outboard outer raceway 44 along a contact line OLC_{O} extending axially between the axial ends 44a, 44b of the raceway 44, as well as contacting the outboard inner raceway 26 along a contact line OLC_{I} extending axially between the axial ends 26a, 26b of the raceway 26. An outboard contact angle CA_{O} is defined by a line L₁ perpendicular to the outboard outer raceway 44 extending through the outboard midpoint circle MC_{O} of the raceway 48 and a line perpendicular PL_{I} to the central axis A_{C}, as best shown in FIG. 6. Further, being a tapered roller, each outboard roller 16 has a frustoconical outer circumferential surface 16a extending between opposing axial ends 16b, 16c and an axial length AL_{O} between the opposing axial ends 16b, 16c. Correspondingly, each one of the outboard inner raceway 26 and the outboard outer raceway 44 has an axial length (not indicated) between the axial ends 26a, 26b and 44a, 44b, respectively, that is at least as great as the roller axial length AL_{O}; that is, the raceway axial length is equal to or greater than a length (not indicated) of the contact line OLC_{I}.

Referring to FIG. 5, similarly, each roller 18 of the inboard row 17 simultaneously contacts the inboard outer raceway 48 along a contact line ILC_{O} extending axially between the axial ends 48a, 48b of the raceway 48, as well as contacting the outboard inner raceway 30 along a contact line ILC_{I} extending axially between the axial ends 30a, 30b of the raceway 30. An inboard contact angle CA_{I} is defined by a line L₂ perpendicular to the inboard outer raceway 44 extending through the inboard midpoint circle MC_{I} of the raceway 44 and a line perpendicular PL_{O} to the central axis A_{C}. Further, the line L₁ perpendicular to the outboard outer raceway 44 and the line L₂ perpendicular to the inboard outer raceway 48 intersect at a vertex point VP, as discussed below. Also, each inboard roller 18 has a frustoconical outer circumferential surface 18a extending between opposing axial ends 18b, 18c and an axial length AL_{I} between the opposing axial ends 18b, 18c, and the inboard inner raceway 30 and the inboard outer raceway 48 each have an axial length (not indicated) between the axial ends 30a, 30b and 48a, 48b, respectively, at least as great as the roller axial length AL_{I}.

Referring now to FIGS. 6 and 7, to optimize the performance of the wheel hub bearing unit 10, the hub 12 and the outer ring 14 are formed or constructed to position the tapered rollers 16, 18 in a manner that has been determined to best balance considerations of friction on the rollers 16, 18 and the stiffness, mass and fatigue life of the wheel hub bearing unit 10. Specifically, the outboard inner and outer raceways 26, 44 and the inboard inner and outer raceways 30, 48 are all configured or formed in accordance with the following structural specifications. First, the vertex point VP defined by the perpendicular lines L₁, L₂ through each midpoint circle MC_{O}, MC_{I} is spaced axially from a center Cs of the midpoint spacing line MSL by a distance DS of no greater than five millimeters (5 mm); that is, within a range of five millimeters (5 mm) from the center Cs in either axial direction along the spacing line MSL. Next, the frustoconical inner surfaces 42, 46 providing the outer raceways 44, 48, respectively, are formed having a respective outboard contact angle CA_{O} and inboard contact angle CA_{I} each with a value between ten degrees) (10° and twenty-five degrees) (25°.

Further, a difference ΔR between the radius RMC_{O} of the outboard midpoint circle MC_{O} and the radius RMC_{I} of the inboard midpoint circle MC_{I} is within a range of three millimeters (3 mm) and ten millimeters (10 mm), with the outboard radius RMC_{O} being greater than the inboard radius RMC_{I}. Finally, either the axial lengths AL_{O}, AL_{I} of the two sets 15, 17 of the rollers 16, 18, respectively, are equal or a ratio LR of the greater axial length AL_{O} or AL_{I} to the lesser axial length AL_{O} or AL_{I} is between 1.0 and 2.0. That is, LR=AL_{O}/AL_{I} and is between 1.0 and 2.0 when the outboard rollers 16 are longer than the inboard rollers 18 or LR=AL_{I}/AL_{O} and is between 1.0 and 2.0 when the inboard rollers 18 are longer than the outboard rollers 16. Although FIGS. 1, 6 and 7 show the inboard rollers 18 as being longer than the outboard rollers 16, such depictions are for convenience only and it is within the scope of the present invention to form or fabricate the outboard rollers 16 of equal length, or longer than, the inboard rollers 18.

With such a structure of the raceways 26, 44, 30, 48 and the relative positioning and sizing of the rollers 16, 18, the stiffness, friction, mass and structural robustness of the bearing unit 10 is affected as follows. When the axial distance DS between the vertex point VP and the center of the midpoint spacing line MSL approaches negative five millimeters (−5 mm), indicating a location more proximal to the outboard row 15 of tapered rollers 16, there is an increase in the stiffness, the friction, the product life and the structural robustness of the bearing unit 10. In contrast, when the axial distance DS between the vertex point VP and the center of the midpoint spacing line MSL approaches positive five millimeters (5 mm), indicating a location more proximal to the inboard row 17 of tapered rollers 18, there is a decrease in the stiffness, the friction, the product life and the structural robustness of the bearing unit 10. Thus, the specific location of the vertex point VP within the range of +/−5 mm is selected dependent upon whether increased stiffness, product life and structural robustness is more desired than a decrease in friction, and vice-versa.

Next, when each outer race contact angle CA_{O}, CA_{I} has a value approaching ten degrees) (10°, the stiffness, friction, product life and structural robustness decreases, and conversely, when the contact angles CA_{O}, CA_{I} each have a value approaching twenty-five degrees) (25°, there is an increase in stiffness, friction, product life and structural robustness. Thus, the specific value of the contact angles CA_{O}, CA_{I} is established closer to 10° when reduced friction is desired and is alternatively established closer to 25° when it is desired to maximize stiffness, life and robustness.

Further, when the difference ΔR between the outboard midpoint circle radius RMC_{O} and the inboard midpoint circle radius MC_{I} approaches three millimeters (3 mm), the stiffness, friction, product life and structural robustness all increase and alternatively, when this difference ΔR approaches ten millimeters (10 mm), each one of the stiffness, friction, product life and structural robustness decreases. As such, when it is desired to increase stiffness, life and robustness, a relative sizing between the midpoint circles MC_{O}, MC_{I} is selected to provide a difference ΔR closer to 3 mm, and a relative sizing providing a difference ΔR closer to 10 mm is selected when reduced friction is desired.

Finally, with the outboard rollers 16 and the inboard rollers 18 axially sized such that the ratio LR of the greater roller axial length ΔL_{O} or AL_{I} to the lesser roller axial length AL_{I}, AL_{O} approaches 1.0, stiffness, friction, product life and structural robustness all decrease and alternatively the stiffness, friction, life and robustness all increase as the ratio LR approaches 2.0. Thus, the rollers 16, 18 are formed with similar axial lengths AL_{O}, AL_{I} when friction is a primary consideration and are alternatively formed such that either the outboard roller axial length AL_{O} is greater than the inboard roller axial length AL_{I}, or vice-versa, when it is desired to increase the stiffness, product life and the robustness of the bearing unit 10.

In a presently preferred construction of the wheel hub bearing unit 10, the above factors are balanced by forming the hub 12 and the outer ring 14 such that the axial distance DS between the vertex point VP and the center of the midpoint spacing line MSL approaches zero (0), each one of the contact angle CA_{O}, CA_{I} has a value of between fourteen degrees) (14° and twenty degrees) (20°, the difference ΔR between the outboard midpoint circle radius RMC_{O} and the inboard midpoint circle radius MC_{I} is greater than six millimeters (6 mm), and the ratio LR of the roller axial lengths AL_{O}, AL_{I} has a value of 1.5 or greater (i.e., LR=AL_{O}/AL_{I}≥1.5 or LR=AL_{I}/AL_{O}≥1.5). However, other applications of the hub bearing unit 10 will of course have different combinations of these factors and are all combinations within the ranges described above are encompassed within the scope of the present invention.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A wheel hub bearing unit for rotatably coupling a wheel with a vehicle, the wheel being rotatable about a central axis, the wheel hub bearing unit comprising:
a hub rotatable about the central axis and having an outboard axial end, an inboard axial end, an annular flange extending radially outwardly from the outboard end and configured to connect with the wheel, a first frustoconical outer circumferential surface providing an outboard inner raceway and a second frustoconical outer circumferential surface spaced axially from the first frustoconical outer circumferential surface and providing an inboard inner raceway; and
an outer ring disposed about the hub and configured to connect with the vehicle, the outer ring having a first frustoconical inner circumferential surface providing an outboard outer raceway, the outboard outer raceway being disposed about the outboard inner raceway, and a second frustoconical inner circumferential surface spaced axially from the first frustoconical inner circumferential surface and providing an inboard outer raceway, the inboard outer raceway being disposed about the inboard inner raceway;
wherein each one of the outboard outer raceway and the inboard outer raceway has first and second axial ends and a midpoint circle centered between the first and second axial ends, an outboard contact angle being defined by a line perpendicular to the outboard outer raceway extending through the midpoint circle of the outboard outer raceway and a line perpendicular to the central axis, and an inboard contact angle being defined by a line perpendicular to the inboard outer raceway extending through the midpoint circle of the inboard outer raceway and a line perpendicular to the central axis, the line perpendicular to the outboard outer raceway and the line perpendicular to the inboard outer raceway intersecting at a vertex point; and
wherein a midpoint spacing line extends axially between the midpoint circle of the outboard outer raceway and the midpoint circle of the inboard outer raceway, the vertex point being spaced axially from a center of the midpoint spacing line by a distance of no greater than five millimeters (5 mm).

2. The wheel hub bearing unit as recited in claim 1, wherein each one of the outboard contact angle and the inboard contact angle has a value between ten degrees) (10° and twenty-five degrees) (25°.

3. The wheel hub bearing unit as recited in claim 1, wherein the midpoint circle of the outboard outer raceway has a radius about the central axis and the midpoint circle of the inboard outer raceway has a radius about the central axis, a difference between the radius of the outboard midpoint circle and the radius of the inboard midpoint circle being within a range of three millimeters (3 mm) and ten millimeters (10 mm).

4. The wheel hub bearing unit as recited in claim 1, further comprising:
an outboard row of tapered rollers disposed between the hub and the outer ring, spaced circumferentially about the central axis and rollable upon the outboard inner raceway and the outboard outer raceway; and
an inboard row of tapered rollers disposed between the hub and the outer ring, spaced circumferentially about the central axis and rollable upon the inboard inner raceway and the inboard outer raceway.

5. The wheel hub bearing unit as recited in claim 4, wherein each roller of the plurality of outboard tapered rollers has an axial length and each roller of the plurality of inboard tapered rollers has an axial length, a ratio of the axial length with a greater value to the axial length with a lesser value being between 1.0 and 2.0.

6. The wheel hub bearing unit as recited in claim 5, wherein the ratio is greater than 1.5.

7. The wheel hub bearing unit as recited in claim 1, wherein:
the hub has a cylindrical main body portion and an annular ring disposed about the main body portion adjacent to the inboard axial end, the annular ring having an outer circumferential surface including the outer frustoconical surface; and
the outer ring has an outer circumferential surface and a flange extending radially outwardly from the outer circumferential surface, the outer ring flange being configured to connect with a steering knuckle or a suspension member of the vehicle.

8. The wheel hub bearing unit as recited in claim 1, wherein a clearance is defined between the annular flange of the hub and an outboard end of the outer ring, the clearance having a value between forty thousandths of a millimeter (0.040 mm) and three hundred thousandths of a millimeter (0.300 mm).

9. A wheel hub bearing unit for rotatably coupling a wheel with a vehicle, the wheel being rotatable about a central axis, the wheel hub bearing unit comprising:
a hub rotatable about the central axis and having an outboard axial end, an inboard axial end, an annular flange extending radially outwardly from the outboard end and configured to connect with the wheel, a first frustoconical outer circumferential surface providing an outboard inner raceway and a second frustoconical outer circumferential surface spaced axially from the first frustoconical outer circumferential surface and providing an inboard inner raceway; and
an outer ring disposed about the hub and configured to connect with the vehicle, the outer ring having a first frustoconical inner circumferential surface providing an outboard outer raceway, the outboard outer raceway being disposed about the outboard inner raceway, and a second frustoconical inner circumferential surface spaced axially from the first frustoconical inner circumferential surface and providing an inboard outer raceway, the inboard outer raceway being disposed about the inboard inner raceway;
wherein each one of the outboard outer raceway and the inboard outer raceway has first and second axial ends and a midpoint circle centered between the first and second axial ends, an outboard contact angle being defined by a first line perpendicular to the outboard outer raceway through the midpoint circle of the outboard outer raceway and an inboard contact angle being defined by a second line perpendicular to the inboard outer raceway through the midpoint circle of the inboard outer raceway, each one of the outboard contact angle and the inboard contact angle having a value between ten degrees) (10° and twenty-five degrees) (25°; and
wherein the midpoint circle of the outboard outer raceway has a first radius about the central axis and the midpoint circle of the inboard outer raceway has a second radius, a difference between the first radius and the second radius being within a range of three millimeters (3 mm) and ten millimeters (10 mm).

10. The wheel hub bearing unit as recited in claim 9, wherein:
the first line perpendicular to the outboard outer raceway and the second line perpendicular to the inboard outer raceway intersect at a vertex point; and
a midpoint spacing line extends axially between the midpoint circle of the outboard outer raceway and the midpoint circle of the inboard outer raceway, the vertex point being spaced axially from a center of the midpoint spacing line by a distance of no greater than five millimeters (5 mm).

11. The wheel hub bearing unit as recited in claim 9, further comprising:
a plurality of outboard tapered rollers disposed between the hub and the outer ring, spaced circumferentially about the central axis and rollable upon the outboard inner raceway and the outboard outer raceway; and
a plurality of inboard tapered rollers disposed between the hub and the outer ring, spaced circumferentially about the central axis and rollable upon the inboard inner raceway and the inboard outer raceway.

12. The wheel hub bearing unit as recited in claim 11, wherein each roller of the plurality of outboard tapered rollers has an axial length and each roller of the plurality of inboard tapered rollers has an axial length, a ratio of the axial length with a greater value to the axial length with a lesser value being between 1.0 and 2.0.

13. The wheel hub bearing unit as recited in claim 12, wherein the ratio is greater than 1.5.

14. The wheel hub bearing unit as recited in claim 9, wherein:
the hub has a cylindrical main body portion and an annular ring disposed about the main body portion adjacent to the inboard axial end, the annular ring having an outer circumferential surface including the outer frustoconical surface; and
the outer ring has an outer circumferential surface and a flange extending radially outwardly from the outer circumferential surface, the outer ring flange being configured to connect with a steering knuckle or a suspension member of the vehicle.

15. The wheel hub bearing unit as recited in claim 9, wherein a clearance is defined between the annular flange of the hub and an outboard end of the outer ring, the clearance having a value between forty thousandths of a millimeter (0.040 mm) and three hundred thousandths of a millimeter (0.300 mm).

16. A wheel hub bearing unit for rotatably coupling a wheel with a vehicle, the wheel being rotatable about a central axis, the wheel hub bearing unit comprising:
a hub rotatable about the central axis and having an outboard axial end, an inboard axial end, an annular flange extending radially outwardly from the outboard end and configured to connect with the wheel, a first frustoconical outer circumferential surface providing an outboard inner raceway and a second frustoconical outer circumferential surface spaced axially from the first frustoconical outer circumferential surface and providing an inboard inner raceway; and
an outer ring disposed about the hub and configured to connect with the vehicle, the outer ring having a first frustoconical inner circumferential surface providing an outboard outer raceway, the outboard outer raceway being disposed about the outboard inner raceway, and a second frustoconical inner circumferential surface spaced axially from the first frustoconical inner circumferential surface and providing an inboard outer raceway, the inboard outer raceway being disposed about the inboard inner raceway;
a plurality of outboard tapered rollers disposed between the hub and the outer ring, spaced circumferentially about the central axis and rollable upon the outboard inner raceway and the outboard outer raceway; and
a plurality of inboard tapered rollers disposed between the hub and the outer ring, spaced circumferentially about the central axis and rollable upon the inboard inner raceway and the inboard outer raceway;
wherein each one of the outboard outer raceway and the inboard outer raceway has first and second axial ends and a midpoint circle centered between the first and second axial ends, an outboard contact angle being defined by a line perpendicular to the outboard outer raceway extending through the midpoint circle of the outboard outer raceway and a line perpendicular to the central axis, and an inboard contact angle being defined by a line perpendicular to the inboard outer raceway extending through the midpoint circle of the inboard outer raceway and a line perpendicular to the central axis, the line perpendicular to the outboard outer raceway and the line perpendicular to the inboard outer raceway intersecting at a vertex point;
wherein a midpoint spacing line extends axially between the midpoint circle of the outboard outer raceway and the midpoint circle of the inboard outer raceway, the vertex point being spaced axially from a center of the midpoint spacing line by a distance of no greater than five millimeters (5 mm);
wherein each one of the outboard contact angle and the inboard contact angle has a value between ten degrees) (10° and twenty-five degrees) (25°, the midpoint circle of the outboard outer raceway has a first radius about the central axis and the midpoint circle of the inboard outer raceway has a second radius, a difference between the first radius and the second radius being within a range of three millimeters and ten millimeters; and
each roller of the plurality of outboard tapered rollers has an axial length and each roller of the plurality of inboard tapered rollers has an axial length, a ratio of the axial length with a greater value to the axial length with a lesser value being greater than 1.5.

17. The wheel hub bearing unit as recited in claim 16, wherein:
the hub has a cylindrical main body portion and an annular ring disposed about the main body portion adjacent to the inboard axial end, the annular ring having an outer circumferential surface including the outer frustoconical surface; and
the outer ring has an outer circumferential surface and a flange extending radially outwardly from the outer circumferential surface, the outer ring flange being configured to connect with a steering knuckle or a suspension member of the vehicle.

18. The wheel hub bearing unit as recited in claim 16, wherein a clearance is defined between the annular flange of the hub and an outboard end of the outer ring, the clearance having a value between forty thousandths of a millimeter (0.040 mm) and three hundred thousandths of a millimeter (0.300 mm).
